(19) United States
(12) Patent Application Publication
(10) Pub. No.: US 2012/0057952 A1
(43) Pub. Date: Mar. 8, 2012

(54) MULTIPURPOSE MACHINE FOR THE AUTOMATIC APPLICATION OF COVERS OR FLYLEAVES AND SPINES

(75) Inventor: Gianni Tognin, Padova (IT)

(73) Assignee: 4 B-FOUR BIND S.r.l., Padova (IT)

(21) Appl. No.: 13/321,203

(22) PCT Filed: Mar. 19, 2010
(86) PCT No.: PCT/IB2010/051202

§ 371 Date: Nov. 18, 2011

(30) Foreign Application Priority Data
May 26, 2009 (IT) PD2009A000151

(51) Int. Cl. B42B 9/00

(52) U.S. Cl. 412/28

(57) ABSTRACT

The present invention concerns a new multipurpose machine for the automatic application of covers or flyleaves and spines, comprising a vice (1) that carries the body of the book and any flyleaves from a jogger (2) on one side to a first lateral glue applicator assembly (3) and a first milling cutter (4) for trimming the body of the book, and on the other side to a second milling cutter (5) for trimming the back of the text blocks, with a second assembly (6) for applying lateral and dorsal glue, and also comprising a device for positioning spines and a press (7) for attaching spines or paperback covers.

### CROSS-REFERENCE TO RELATED APPLICATIONS

This application is a 371 U.S. National Stage of International Application No. PCT/IB/2010/051202, filed Mar. 19, 2010, and claims priority to Italian patent application No. PD2009A000151, filed May 26, 2009, the disclosures of which are herein incorporated by reference in their entirety.

### FIELD

The present disclosure concerns machines for finishing books and in particular concerns machines for the application of book covers, flyleaves and spines.

### BACKGROUND

This section provides background information related to the present disclosure which is not necessarily prior art.

Books, whether they consist of simple sheets coupled or text blocks bound and coupled, are finished using two different types of covers: paperback and/or hardback.

The set of sheets or text blocks is commonly known as the body of the book.

It is customary to convey the body of the book to the various work processes with its back facing downwards so that the height of each page is in a horizontal direction and its width is in a vertical direction. The paperback cover consists of a printed sheet, normally thicker than the pages of the book, which covers the first page, the back and the last page of the book. The front and back face of the cover have a fold corresponding to the back of the book, parallel to said back of the book. Said paperback cover is glued onto the edges of the first and last sheet near the back and on the back itself.

The hardback cover comprises two rigid sheets, called boards, joined by a third element, the back. This hardback cover is not glued directly onto the sheets of the book but onto two specific sheets called flyleaves.

Each flyleaf consists of a sheet having length identical to the pages of the body of the book carried and height equal to twice the height of each page of the body of the book so that when it is folded it has the configuration of two adjacent pages, so that its folding edge is positioned alongside and aligned with the backs of the text blocks of the body of the book, as if the folded flyleaf were a further text block. Said fold of the flyleaves constitutes a joining element between the body of the book and the cover and must never be eliminated even in the case of milling of the body of the book.

A pressing operation in a transverse direction, together with a line of glue between the fold of each flyleaf and the back of the sheet of the body of the book adjacent to said flyleaf guarantees subsequent adhesion between flyleaves and body of the book.

The state of the art in the preparation of books for paperback covers entails the application of a strip of paper which constitutes a joining element, called spine, on the part of the book body with flyleaves which have been spread with glue on the back and on both sides with the function of covering and wrapping the backs and any stitching of the text blocks and flyleaves and an area near to said backs of the last and first flyleaf.

The outer sheets of the two flyleaves are lastly glued to the inner faces of the two cover pages, thus fixing the rigid cover to the text blocks.

For application on the text blocks, each of the two types of cover requires various operations, many of which are specific for the particular type of cover.

Automatic machines are known for the application of paperback covers to text blocks. Said automatic machines permit various regulations, for example the thickness of the text blocks, the dimensions of the sheets, the amount of glue to be distributed, etc., but do not permit the application of covers other than paperbacks to text blocks.

Automatic or semiautomatic machines are known for application to text blocks of only flyleaves and spines for hardback covers. Similarly to the previous ones, these automatic or semiautomatic machines also permit various regulations, but do not permit the application of covers other than hardback covers or only flyleaves with spines.

Normally a bookbindery has to apply both hardback covers and paperback covers, for a large number of text blocks.

Consequently each bookbindery needs to use at least two different and separate machines for the application of covers.

This involves various drawbacks.

Each cover application machine has large overall dimensions, consequently they require large rooms for the installation of said two machines, with space for the text blocks to be covered for each type of cover and the covered text blocks ready to be sent to the next stage in the binding process.

Each of the two cover application machines are expensive to purchase and have high routine and extraordinary maintenance costs. The presence of the two types of machines requires two spare parts suppliers, two suppliers for the specific consumable parts and two technical support services.

Various technical support and spare parts supply services may meet the needs of both the machines, but different spare parts are required nevertheless.

Each machine has its own specific operation, consequently each machine requires a person who is specialised or has been specifically trained in its operation, regulation and routine maintenance.

### SUMMARY

This section provides a general summary of the disclosure, and is not a comprehensive disclosure of its full scope or all of its features.

The subject of this disclosure is a new automatic or semiautomatic machine for continuous application of both paperback covers, and flyleaves and spine.

The object of the new machine is to apply both the paperback covers and flyleaves with spine to the body of the book, according to the state of the art.

A further object of the new machine is to apply in automatic or semiautomatic mode paperback covers or flyleaves with spine to the body of the book without substantially modifying the structure of the machine.

These and further objects, direct and complementary, are achieved by the new automatic or semi-automatic machine for continuous application of paperback covers and flyleaves and spine to the body of the book comprising, in its main parts, a travelling vice equipped with suction jaws for carrying the body of the book, at least one jogger, at least one milling cutter for trimming the backs of the text blocks, at least one lateral glue applicator assembly, at least one assembly for applying glue laterally and on the back of the text blocks, at least one device for positioning the spines and at least one press for application of spines and/or paperback covers.

All these various parts of the new machine are arranged along a operating directrix coplanar to the sheets of the book bodies.

In particular the various parts of the new machine are distributed along said operating directrix on the two sides with respect to the arrival point of the book bodies:

on one side at least one lateral glue applicator assembly and at least one milling cutter for trimming the backs of the text blocks are provided;

on the other side at least one milling cutter for trimming the backs of the text blocks, at least one applicator assembly for applying glue laterally and on the backs of the text blocks, at least one spine positioning device and at least one press for application of spines and/or paperback covers are provided.

The characteristics of the new automatic or semi-automatic machine for continuous application of paperback covers or flyleaves and spine to the bodies of books will be better clarified by the following description with reference to the drawing, attached by way of non-limiting example.

### DRAWINGS

The drawings described herein are for illustrative purposes only of selected embodiments and not all possible implementations, and are not intended to limit the scope of the present disclosure.

FIG. 1 shows schematically the various parts of a multipurpose machine;

FIGS. 2A and 2B are perspective views of a vice of the multipurpose machine;

FIG. 3 is a perspective view of a lateral glue applicator assembly of the multipurpose machine;

FIG. 4 is a perspective view of a milling cutter of the multipurpose machine;

FIG. 5 is a perspective view of another milling cutter of the multipurpose machine; and

FIGS. 6A and 6B show schematically a press of the multipurpose machine.

Corresponding reference numerals indicate corresponding parts throughout the several views of the drawings.

### DETAILED DESCRIPTION

Example embodiments will now be described more fully with reference to the accompanying drawings.

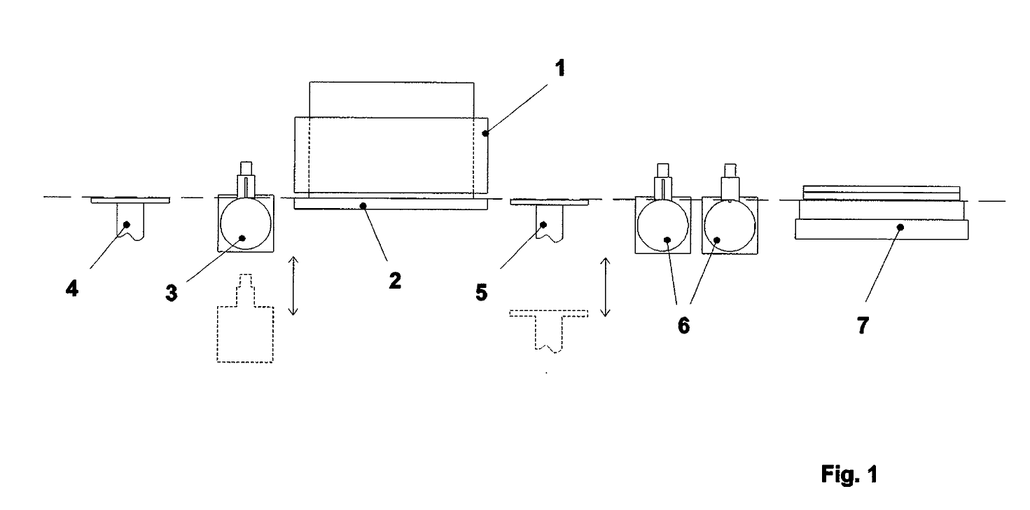

FIG. 1 shows schematically the various parts of the multipurpose machine.

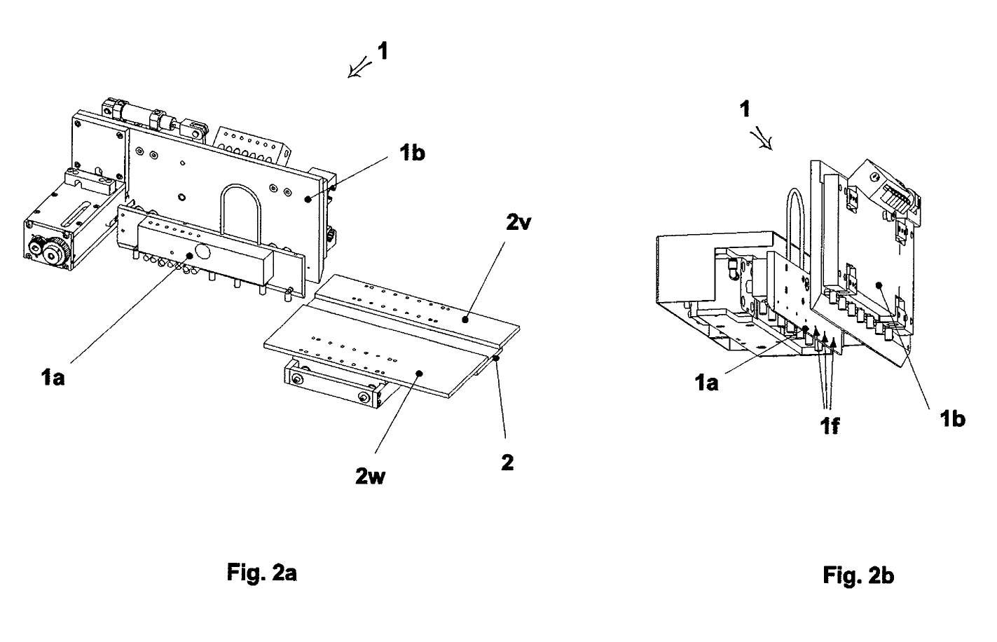

The vice (1), shown schematically in FIGS. 2a and 2b, comprises at least two parallel planes called jaws (1a, 1b) which can be moved towards each other and are each provided with suction holes (1f) to separate the first sheet adjacent to each plane (1a, 1b) and comprised between the two planes (1a, 1b).

The vice (1) constituted as above can be moved both horizontally, along the plane parallel to the two planes (1a, 1b) of the vice (1), and vertically.

The vice (1) receives the body of the book in its initial position, which is also the position for starting work, as illustrated in FIG. 1, and then carries it to the other parts of the new machine where the necessary operations are performed.

The vice (1) is initially positioned on the jogger (2), the position for starting work, in which it receives the text blocks of the book body, consisting of text blocks and any flyleaves.

Said jogger (2) consists of a plane (2), having at the top two plates (2v, 2w) adhering to and moving on said plane (2) on which the text blocks of the body are placed with any flyleaves to align the backs of the text blocks.

The other parts of the new machine are located at the sides of the jogger (2), on the plane of the sheets of the text blocks.

On one side are a first lateral glue applicator assembly (3) and a first milling cutter (4) for trimming the book body.

On the other side are a second milling cutter (5) for trimming the back of the text blocks, a second lateral and dorsal glue applicator assembly (6), a spine positioning device and a press (7) for application of spines or paperback covers.

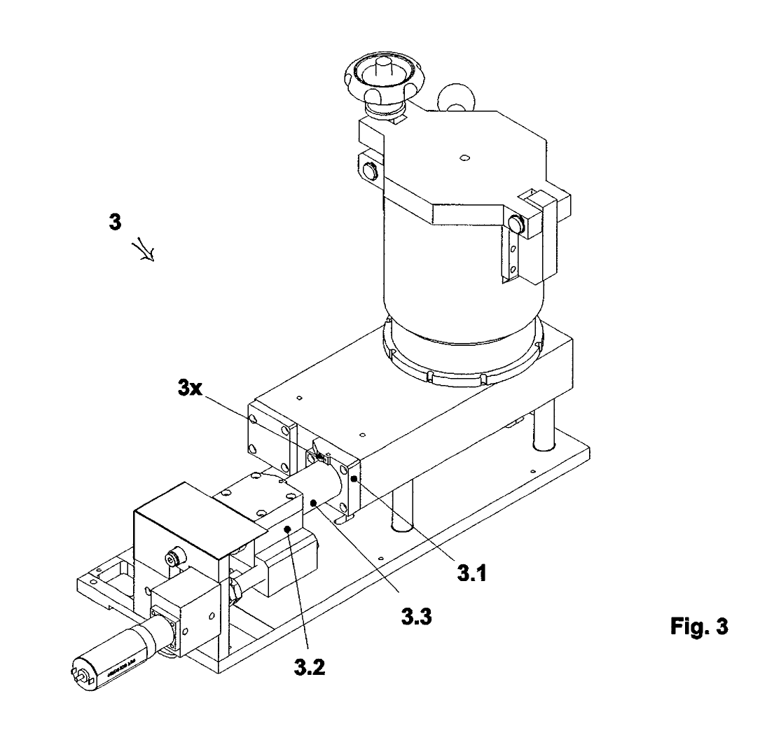

The first lateral glue applicator assembly (3), shown schematically in FIG. 3, consists mainly of a support (3.3), orthogonal to the plane of the sheets of the text blocks, provided with two guides (3.1, 3.2) with openings (3x) for dispensing the glue on the respectively facing vertical side.

In particular a first guide (3.1) is fixed to the support (3.3) but can be adjusted integral with the latter in the direction of its axis, while the second guide (3.2) slides on said support (3.3) thus adapting to the thickness of the book body.

Said first lateral glue applicator assembly (3) is suitable for depositing a layer of glue, which can be hot-melt or PUR polyurethane hot-melt on the lower lateral edge of the lateral sheets of the book body corresponding to the area near the back of the book. Said layer can be mechanically height-varied.

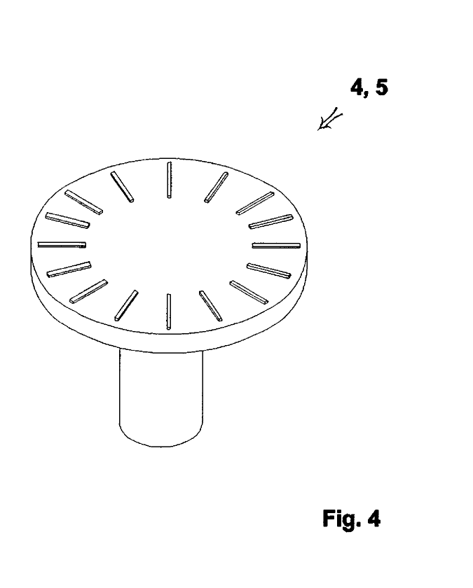

The first milling cutter (4) for trimming the back of the text blocks, shown schematically in FIG. 4, consists of a known milling cutter for trimming and shaping the backs of the text blocks, thus permitting greater penetration of the glue in the subsequent gluing phase.

The second milling cutter (5), located on the other side with respect to the jogger (2) and identical or similar to the one shown in FIG. 4, consists of a known milling cutter for trimming and shaping the backs of the text blocks, thus permitting greater penetration of the glue.

The second milling cutter (5) can be moved vertically, from an operating position in which it is generically at the height of the jogger (2), when the machine is working on a paperback cover, to a rest position, i.e. lowered below the height of the jogger (2), when the machine is preparing the book block for a hardback cover.

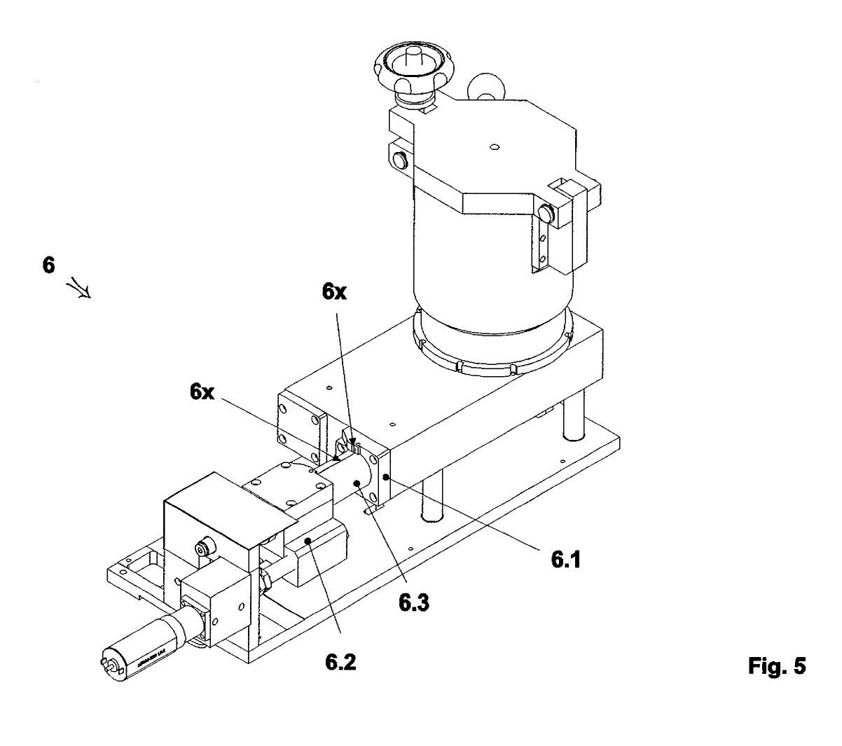

The second lateral and lower glue applicator assembly (6), shown schematically in FIG. 5, consists mainly of a support (6.3), orthogonal to the plane of the sheets of the text blocks, provided with two guides (6.1, 6.2).

In particular the guides (6.1, 6.2) have openings (6x) for dispensing the glue on the respectively facing vertical side and the support (6.3) has an upper opening (6x) for dispensing the glue aligned with the length of said support and orthogonal to the plane of the sheets of the text blocks.

A guide (6.1) is fixed to the support (6.3) but can be adjusted integral with the latter in the direction of its axis, while the other guide (6.2) slides on the support (6.3) thus adapting to the thickness of the body of the book.

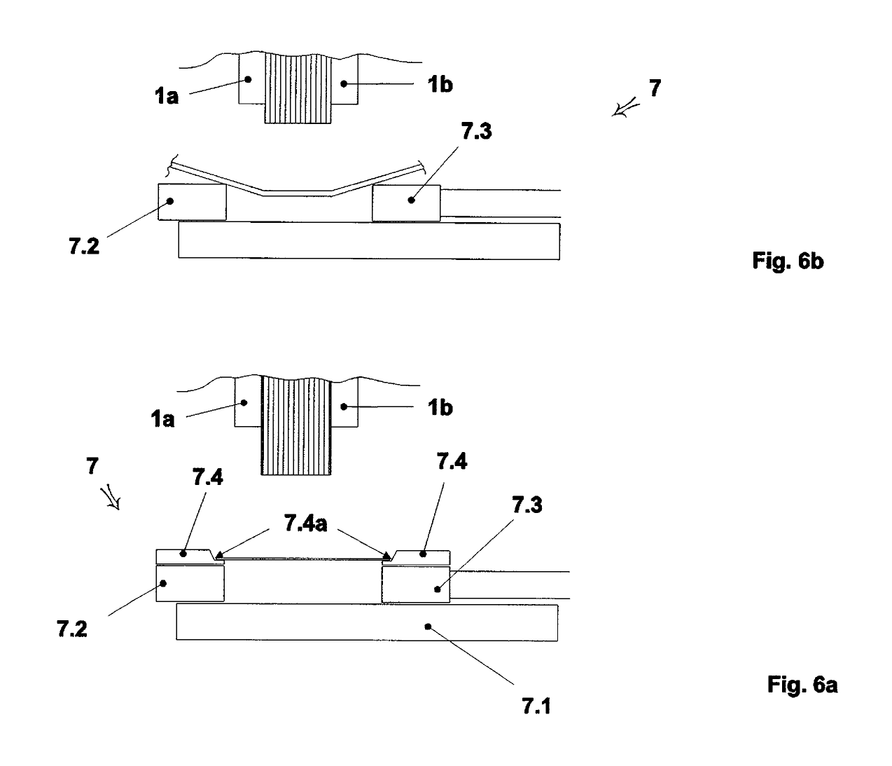

The press (7) for application of spines or paperback covers, shown schematically in FIGS. 6a and 6b, comprises: a supporting plane (7.1), a striker bar (7.2), a pressing bar (7.3), two travelling supports (7.4) for spine positioning.

The supporting plane (7.1) consists of a plane which receives the back of the body of the book.

The striker bar (7.2) consists of a bar which can be rested integral with said supporting plane (7.1) or adhering and travelling on said supporting plane and parallel to the plane of the sheets of the book bodies.

The pressing bar (7.3) consists of a bar adhering to said supporting plane (7.1), parallel to the striker bar (7.2) and travelling on said supporting plane (7.1) in a direction orthogonal to said striker bar (7.2). The two travelling supports (7.4) for spines consist of two shaped profiles, parallel to the supporting plane (7.1) and each parallel and overlapping one of the two striker (7.2) and pressing (7.3) bars.

Said two travelling supports (7.4) are independent of said striker bar (7.2) and pressing bar (7.3) and can be moved both in a direction orthogonal to each other, thus adapting them to different spine sizes, and in a direction parallel to the travelling supports (7.4) and to the striker bar (7.2) and pressing bar (7.3), thus moving them away when not needed.

In particular each of said two travelling supports (7.4) has a genetically L-shaped profile, or a groove (7.4a) or supporting seat facing upwards and towards the other travelling support (7.4) thus being able to receive and sustain the long edges of a spine.

Said parts of the new automatic or semiautomatic machine for continuous application of paperback covers or flyleaves and spine are used or not used depending on the type of application required, paperback cover or flyleaves with spine.

The vice (1) receives the body of the book in its initial position, as illustrated in FIG. 1, and then carries it to the other parts of the new machine where the necessary operations are performed.

In particular the body of the book is placed between the two planes (1a, 1b) of the vice (1) with the backs of the text blocks facing downwards.

The vice (1) has its planes (1a, 1b) open so as to allow the body of the book to descend until all the text blocks rest on the jogger (2).

In the case of application of paperback covers to the body of the books, the new machine performs the operations described below. The vice (1) has its planes (1a, 1b) open slightly thus allowing all the text blocks to descend and rest their backs on the plane of the jogger (2).

The planes (1a, 1b) of the vice (1) close, clamping the body of the book, and the vice (1) carries said body of the book towards the second milling cutter (5).

The second milling cutter (5), in this sequence, is raised to the operating position and performs trimming and shaping of the backs of the text blocks.

The vice (1) continues its movement towards the second glue applicator assembly (6).

In particular the lower part of the body of the book carried by the vice (1) passes through the two guides (6.1, 6.2) and onto the support (6.3), so that the glue dispensed through the openings (6x) of said support (6.3) and said guides (6.1, 6.2) is spread on the backs of all the text blocks and on the lower lateral edge of the lateral sheets of the book body corresponding to the area near the back of the book.

In the meantime a specific mechanism or an operator has positioned a paperback cover on the press (7).

In this operating sequence of the new machine, the two travelling supports (7.4) for spines are moved away from the supporting plane (7.1) and from the striker bar (7.2) and pressing bar (7.3), as illustrated in FIG. 6b.

The cover is placed on the two striker (7.2) and pressing (7.3) bars so that the back of the cover is parallel to said bars, above the supporting plane (7.1) and near the striker bar (7.2).

The vice (1), which carries the body of the book with the back trimmed and shaped and with the glue deposited, moves, positioning the body of the book on the press (7).

At this point the press (7) is operated and in particular the pressing bars (7.2) which, by travelling in the opposite direction, compress the edge of the two pages of the cover near the back and the edge of the outer text blocks near to their backs.

In this way the back of the cover and the edges of its pages near the back are joined to the backs of the text blocks and to the edges of the outer text blocks near their backs.

The press (7) maintains the compression position for a few seconds, or for the time necessary for the glue to cool and set, and subsequently moves the pressing bars (7.2) away from the striker bar (7.1).

If flyleaves or spines have to be applied to the body of the books, the new machine performs the operations described below.

The body of the book, which can consist of single sheets or sheets folded even several times, is placed in the vice (1) including the front and back flyleaves having their fold running alongside the backs of the text blocks.

The flyleaves must appear as a sheet which, after being folded in half, must have the dimensions of the text blocks of the book body and its fold must never be eliminated by the subsequent milling phases.

In particular the body of the book with the flyleaves is placed between the two jaws (1a, 1b) of the vice (1) with the backs of the text blocks and flyleaves facing downwards.

The vice (1) has its planes (1a, 1b) open to allow the body of the book to descend until all the text blocks, and the flyleaves, rest on the jogger (2).

In this phase the two plates (2v, 2w) of the jogger (2) are open, thus allowing all the backs of the text blocks and flyleaves to rest on the plane of the jogger (2).

The suction devices (1f) of the planes (1a, 1b) of the vice (1) are activated, thus retaining only the flyleaves on the opposite faces of said planes (1a, 1b).

The vice (1), with the planes (1a, 1b) not pressed on the text blocks, moves back up, raising the flyleaves by a few millimetres from the supporting plane of the jogger (2) and leaving the text blocks of the book body resting on the jogger (2).

The planes (1a, 1b) of the vice (1) close, clamping the entire body of the book with the flyleaves, and carry it through the first lateral glue applicator assembly (3) and a first milling cutter (4) for trimming the back of the text blocks.

Initially the first glue applicator assembly (3) is de-activated or lowered, thus allowing free transit of the vice (1) and body of the book towards the first milling cutter (4).

Alternatively to the vertical movement of said glue applicator assembly (3), its guides (3.1, 3.2) can be opened thus allowing the body of the book to pass through.

The body of the book is carried by the vice (1) to the first milling cutter (4) which trims and shapes the backs of the text blocks.

After the passage of the vice (1) with the body of the book towards the first milling cutter (4), the first glue applicator assembly (3) is raised to the operating position. In the case of guides (3.1, 3.2) that can be opened, they are re-closed to the operating position.

When the backs of the text blocks have been finished by the first milling cutter (4), the vice (1) inverts its movement, repositioning the body of the book towards the jogger (2).

Said return movement of the vice (1) entails the body of the book passing between the two guides (3.1, 3.2) of the first glue applicator assembly (3), which in the meantime has been raised again or has re-closed its guides (3.1, 3.2).

In particular the lower part of the body of the book carried by the vice (1) passes through the two guides (3.1, 3.2) of the support (3.3), so that the glue dispensed through the openings (3x) of said guides (3.1, 3.2) is spread on the lower outer edges of the lateral sheets of the book body corresponding to the area near the back of the book. Since the flyleaves are raised with respect to the backs of the text blocks, they do not receive and are not involved in this phase in distribution of the glue by the guides (3.1, 3.2) of the first glue applicator assembly (3), likewise they are not involved in the preceding trimming operation.

The body of the book is carried by the vice (1) to the jogger (2) so that the backs of the text blocks rest on the jogger (2) in the beginning of work position.

The planes (1a, 1b) of the vice (1) are spaced and the suction is interrupted, if still active, thus freeing both the text blocks and the flyleaves which, no longer retained, descend until their folds rest on the plane of the jogger (2).

Alternatively the planes (1a, 1b) of the vice (1) can be spaced slightly and lowered, without interrupting the suction, thus lowering the flyleaves and aligning the lower edges with the folds or lower edges of the text blocks resting on the plane of the jogger (2) which has its plates (2v, 2w) open.

The subsequent re-closure of the two plates (2v and 2w) adhering and travelling on the plane of the jogger (2) (FIG. 2a) causes the flyleaves to adhere to the text blocks and in particular compresses the folds of the flyleaves onto the glue deposited on the edges near the backs of the text blocks, thus fixing the flyleaves on said text blocks.

Subsequently the vice (1) clamps and carries said body of the book with glued flyleaves towards the second milling cutter (5).

The second milling cutter (5), in this sequence, is lowered to the non-operating position.

The vice (1) continues its movement towards the second glue applicator assembly (6).

In particular the lower part of the body of the book with flyleaves carried by the vice (1) passes through the two guides (6.1, 6.2), so that the glue dispensed through the openings (6x) of the support (6.3) is deposited on the backs of all the text blocks and on the sides near the back and the flyleaves.

In this operating sequence of the new machine, the two travelling supports (7.4) for spines overlap the striker bar (7.2) and pressing bar (7.3), as illustrated in FIG. 6a.

A specific automatic mechanism, called automatic feed device, or an operator has positioned a spine on said travelling supports (7.4) so that the long edges of the spine are housed and sustained by the grooves (7.4a) or supporting seats of said travelling supports (7.4).

The vice (1), which carries the body of the book with the flyleaves and with the glue deposited, travels towards the press (7), positioning the body of the book on the press (7).

At this point the press (7) is activated and in particular the pressing bars (7.2) which, as they move, compress the bands of the spine onto the lower lateral edges of the flyleaves corresponding to the area near the back of the book.

In this way the spine is joined to the backs of the text blocks and to the outer edges of the flyleaves near to their backs.

The press (7) maintains the compression position for a few seconds, or the time necessary for the glue to cool and set, and then re-opens and moves the pressing bars (7.2) and (7.3) and the abutment plate (7.1) away from operating position.

The vice (1) continues its movement towards the second glue applicator assembly (6).

In particular the lower part of the body of the book with flyleaves carried by the vice (1) passes through the two guides (6.1, 6.2), so that the glue dispensed through the openings (6x) of the support (6.3) is deposited on the backs of all the text blocks and on the sides near the back and the flyleaves.

In this operating sequence of the new machine, the two travelling supports (7.4) for spines overlap the striker bar (7.2) and pressing bar (7.3), as illustrated in FIG. 6a.

A specific automatic mechanism, called automatic feed device, or an operator has positioned a spine on said travelling supports (7.4) so that the long edges of the spine are housed and sustained by the grooves (7.4a) or supporting seats of said travelling supports (7.4).

The vice (1), which carries the body of the book with the flyleaves and with the glue deposited, travels towards the press (7), positioning the body of the book on the press (7).

At this point the press (7) is activated and in particular the pressing bars (7.2) which, as they move, compress the bands of the spine onto the lower lateral edges of the flyleaves corresponding to the area near the back of the book.

In this way the spine is joined to the backs of the text blocks and to the outer edges of the flyleaves near to their backs. The press (7) maintains the compression position for a few seconds, or the time necessary for the glue to cool and set and then re-opens and moves the pressing bars (7.2) and (7.3) and the abutment plate (7.1) away from the book block.

The body of the book thus provided with flyleaves and spine is taken out by the operator or left to drop through the press into the part below or onto a conveyor belt.

Therefore with reference to the preceding description and the accompanying drawings, the following claims are made.

1. A machine for the automatic application of covers or flyleaves and spines to the body of books, defined more simply as a multipurpose machine, comprising:
a travelling vice having two gripping planes for carrying the body of the book placed with its back facing downwards;
at least one jogger having a generically horizontal plane for knocking up backs of the text blocks;
at least one edge pressing unit having two plates with an opening and closing movement;
at least one milling cutter for trimming the back of sheets or text blocks;
at least one lateral glue applicator device;
at least one applicator assembly for applying glue laterally and on the back of at least one of the sheets, text blocks or flyleaves;
at least one manually or automatically adjustable assembly for positioning the spines,
wherein:
said travelling vice includes a suction device that bring a suction action to bear on two flyleaves,
said travelling vice includes means for partially loosening said gripping planes and displacing them vertically with respect to said jogger, consequently lifting the two flyleaves held integrally with said gripping planes by said suction action.

2. The multipurpose machine for the application of book covers according to claim 1, wherein said vice, comprising said two parallel planes capable of travelling towards one another and each equipped with the suction device for exerting a suction action on the sheet adjacent to said plane and in between the two planes, carries the body of the book vertically and horizontally to the various other parts of the machine on the vertical plane parallel to the sheets of the text blocks

3. The multipurpose machine for the application of book covers according to claim 1, wherein the jogger is located underneath a position in which the body of the book is loaded in the vice and it is fitted with two plates, sliding on the plane of said jogger, for pressing the edges of the flyleaves onto the edges of the text blocks.

4. The multipurpose machine for the application of book covers according to claim 1, wherein adjacent to said jogger, on the same plane as the sheets of the text blocks, there are a first lateral glue applicator assembly and a first milling cutter for trimming the back of the text blocks, and wherein said vice carries the body of the book sequentially to the first milling cutter and subsequently to the first lateral glue applicator assembly.

5. The multipurpose machine for the application of book covers according to claim 4, wherein said first lateral glue applicator assembly is closer to the jogger, and wherein said first glue applicator assembly can be transferred vertically and lowered during a first passage of the vice carrying the body of the book towards the first milling cutter, and then raised into position for use when the vice returns towards the jogger.

6. The multipurpose machine for the application of book covers according to claim 4, wherein said first lateral glue applicator assembly is closer to the jogger, and wherein said first glue applicator assembly opens its guides during a first passage of the vice carrying the body of the book towards the first milling cutter, and closes said guides again into position for use when the vice returns towards the jogger.

7. The multipurpose machine for the application of book covers according to claim 4, wherein on another side of the jogger, on the same plane as the sheets of the text blocks, there are a second milling cutter, that can be transferred vertically and lowered, and thus be excluded during the application of flyleaves and spines, or that can remain in position for use during the application of paperback covers, a second lower lateral and dorsal glue application, and a press for the application of spines or paperback covers.

8. The multipurpose machine for the application of book covers according to claim 7, wherein said press comprises a supporting plane, an integral or adhering striker bar lying parallel to the plane of the sheets in the bodies of the books that travels on said supporting plane, a pressing bar adhering to said supporting plane and parallel to the striker bar, and travelling on said supporting plane in a direction orthogonal to said striker bar.

9. The multipurpose machine for the application of book covers according to claim 8, wherein said press has two travelling elements for supporting spines that can overlap said striker bar and pressing bar, comprising two shaped profiles parallel to the supporting plane and to said striker bar and pressing bar, and wherein said two travelling supporting elements can travel in a direction orthogonal to one another, so as to adapt them to different spine sizes, as well as in a direction parallel to the travelling supporting elements and to the striker and pressing bars, so as to move them away when they are not needed.

10. The multipurpose machine for the application of covers to the body of books according to claim 1, wherein the application of paperback covers involves the following steps:
the body of the book is placed between the open planes of the vice so that all the backs of the text blocks rest against the jogger, then the vice closes its planes to retain and carry said body of the book,
the body of the book is brought up to the milling cutter for the trimming and shaping of the backs of the text blocks,
the body of the book is then carried to the application assembly for the application of glue on the back of the text blocks and on the other lower lateral edges of the outermost sheets of the body of the book, and
the body of the book is then carried to a press, which presses the paperback cover, previously positioned on the press, against the back of the body of the book and against the lower outer edges.

11. The multipurpose machine for the application of covers to the body of books according to claim 1, wherein the application of flyleaves and spines involves the following steps:
the body of the book complete with the flyleaves is placed between the open planes of the vice so that all the backs of the text blocks and of the flyleaves rest against the jogger,
the vice juxtaposes the planes without closing them and the suction device on said planes are operated so as to retain the flyleaves against said planes,
the planes of the vice are raised so as to lift the flyleaves thus retained away from the body of the book and the jogger,
the planes of the vice are then closed and tightened so as to retain and carry said body of the book with the flyleaves raised,
the body of the book is brought up to the milling cutter for the trimming and shaping of the backs of the text blocks as necessary,
the body of the book is then carried to an applicator assembly for the application of glue to the lower lateral edges of the outermost sheets of the book in the vicinity of the backs of the text blocks,
the body of the book is then carried on the same or another jogger where the planes of the vice are opened slightly and they descend so as to align the edges of the flyleaves with the edges of the backs of the text blocks,
the planes of the edge pressing unit are then closed and tightened to join said flyleaves to the text blocks forming the body of the book, which have been previously spread laterally with glue,
the body of the book is carried to the applicator assembly that apply glue to the back of the text blocks and to the lower lateral edge of the flyleaves, and
the body of the book is then carried to a press, which presses a spine, previously positioned on the travelling supporting elements of said press, onto the back of the text blocks and onto the lower edge of the flyleaves.

12. The multipurpose machine for the application of book covers according to claim 2, wherein the jogger is located underneath a position in which the body of the book is loaded in the vice and it is fitted with two plates, sliding on the plane of said jogger, for pressing the edges of the flyleaves onto the edges of the text blocks.

13. The multipurpose machine for the application of book covers according to claim 2, wherein adjacent to said jogger, on the same plane as the sheets of the text blocks, there are a first lateral glue applicator assembly and a first milling cutter for trimming the back of the text blocks, and wherein said vice carries the body of the book sequentially to the first milling cutter and subsequently to the first lateral glue applicator assembly.

14. The multipurpose machine for the application of book covers according to claim 3, wherein adjacent to said jogger, on the same plane as the sheets of the text blocks, there are a first lateral glue applicator assembly and a first milling cutter for trimming the back of the text blocks, and wherein said vice carries the body of the book sequentially to the first milling cutter and subsequently to the first lateral glue applicator assembly.

15. The multipurpose machine for the application of book covers according to claim 1, wherein on a side of the jogger, on the same plane as the sheets of the text blocks, there are a second milling cutter, that can be transferred vertically and lowered, and thus be excluded during the application of flyleaves and spines, or that can remain in position for use during the application of paperback covers, a second lower lateral and dorsal glue applicator, and a press for the application of spines or paperback covers.

16. The multipurpose machine for the application of book covers according to claim 2, wherein on a side of the jogger, on the same plane as the sheets of the text blocks, there are a second milling cutter, that can be transferred vertically and lowered, and thus be excluded during the application of flyleaves and spines, or that can remain in position for use during the application of paperback covers, a second lower lateral and dorsal glue applicator, and a press for the application of spines or paperback covers.

17. The multipurpose machine for the application of book covers according to claim 3, wherein on a side of the jogger, on the same plane as the sheets of the text blocks, there are a second milling cutter, that can be transferred vertically and lowered, and thus be excluded during the application of flyleaves and spines, or that can remain in position for use during the application of paperback covers, a second lower lateral and dorsal glue applicator, and a press for the application of spines or paperback covers.
